(19) United States
(12) Patent Application Publication
(10) Pub. No.: US 2006/0220785 A1
(43) Pub. Date: Oct. 5, 2006

(54) Generic radio transmission network for door applications

(76) Inventor: Torbjoern Ferdman, Haverdal (SE)

Correspondence Address: FROMMER LAWRENCE & HAUG, 745 FIFTH AVENUE- 10TH FL., NEW YORK, NY, 10151, US

(21) Appl. No.: 11/095,904

(22) Filed: Mar. 31, 2005

(51) Int. Cl. G05B 19/00

(52) U.S. Cl. 340/5.61; 340/540; 340/5.71

(57) ABSTRACT

A wireless radio transmission network comprising: one or more high-speed doors; one or more stationary radio transceivers, each of the one or more stationary radio transceivers having a unique identifier; and one or more mobile radio transceivers, each of the one or more mobile radio transceivers having a unique identifier; wherein when a mobile transceiver approaches within a predetermined distance of a stationary transceiver and when the unique identifier of the stationary transceiver verifies that the unique identifier of the mobile transceiver is an acceptable identifier, a high-speed door is triggered to open.

### BACKGROUND OF THE INVENTION

1. Field of the Invention

The present invention relates to a radio unit or a radio transceiver that is used in door applications. Specifically, the present invention comprises a plurality of stationary and mobile radio transceivers that are triggered to facilitate the rapid opening and closing of doors.

2. Description of the Related Art

There has been a great need to use rapidly moving doors in buildings for industrial use. This applies to indoor openings as well as to external walls, where one or more doors provide shielding between different activities or prevent drafts and heat losses.

Presently, rolling doors with flexible door leaves are used for this purpose, but also more rigid constructions like slatted doors with polymeric or metallic lamellae are used. These doors are rolled up on an overhead drive cylinder and can be provided with additional elements like a weight balance system, tensioning system, windows or the like. For safety reasons, rolling doors can be provided with safety edge protection, failsafe devices drop protection, etc. As understood from the above, rollup doors are available in different styles and materials.

Remote control door-opening devices have been used for door applications for many years. These remote control door-opening devices have typically been based on a transmitter/receiver configuration. In other words, when a valid message is transferred from a transmitter to a door, which contains a receiver, the door is then triggered to open.

As is well known, remote control door-opening devices are available that include a transmitter that transmits a signal to be received by a receiver associated with a garage door in order to remotely open and close the garage door. However, most of these systems include a single transmitter/receiver configuration.

One known device for remotely controlling and accessing a plurality of doors is disclosed in U.S. Published Patent Application No. 2002/0130788 to Chang. The device described in the '788 publication is a remotely controlled door lock system. The remote controller has a receiver circuit for receiving a confirm signal transmitted by the door lock.

Another device for remotely controlling doors is disclosed in U.S. Pat. No. 6,072,404 to Nolan et al. The device of the '404 patent is a universal garage door opener. The door opener includes receiver circuitry that is responsive to conventional door opener signals so that the remote controller can re-create the transmission signal for future use.

Still another apparatus is disclosed in U.S. Pat. No. 6,720,861 to Rodenbeck et al. The device of the '861 patent provides a wireless security control system that grants or denies access to a specific user seeking access to a specific door. A user-carried “token” (e.g., smart card, magnetic strip, biometric, etc.) provides information to a central controller which in turn passes information to the specific door to be opened.

Still another apparatus is disclosed in U.S. Pat. No. 5,721,550 to Lopez. The device of the '550 patent is a two channel remote control system for starting an automobile engine and activating accessories within the vehicle. A remote receiver held by the operator informs the operator of the status of the vehicle systems.

Still another apparatus is disclosed in U.S. Pat. No. 6,727,816 to Helgeson. The device of the '816 patent discloses a building control system with multiple remote transceivers having adjustable transmission power communicating with a master transceiver.

Still another apparatus is disclosed in U.S. Pat. No. 5,465,081 to Todd. The device of the '081 patent has multiple fixed-position low-power transceivers that communicate with each other and relay communications with a control transceiver.

Still another apparatus is disclosed in U.S. Pat. No. 5,323,149 to Hoult et al. The device of the '149 patent provides a master/slave system using plural remote transceivers and a master transceiver for building access control.

Still another apparatus is disclosed in U.S. Pat. No. 6,218,929 to Furuta et al. The device of the '929 patent is a remote keyless entry system for a vehicle. The remote unit demodulates a specific signal received from the vehicle control unit and in return transmits the modulated signal to the control unit.

Still another apparatus is disclosed in U.S. Pat. No. 6,281,599 to Murakami et al. The device of the '599 patent is a remote control entry system for a vehicle. The vehicle-mounted control unit sends an ID request to the hand-held remote which transmits an ID reply.

However, most of these systems of the related art include a transmitter/receiver configuration. This configuration is complex, bulky, expensive and consumes excessive amounts of battery power due to transmitter repetitions.

For the foregoing reasons, there is a need for a system and method for utilizing a transceiver configuration in a local area network (LAN) environment in order to rapidly and efficiently open and close doors. Further, there is a need for a device that reduces the cost of present remote control systems by reducing the hardware associated with such remote control systems.

### SUMMARY OF THE INVENTION

It is an object of the present invention to provide a door opening and closing device having a conventional transceiver in order to receive acknowledgment of receipt of a command from a door unit to rapidly open and close doors.

It is a further object to reduce transmitter repetitions and save battery power, to provide a battery-powered door-opening transceiver unit that eliminates cables, to provide a wireless control system in order to eliminate wiring, to provide a door-to-door radio communication that eliminates wiring, to provide door unit relay status via a network to a display, and to provide a door to a host computer or concentrator communication.

It is a further object of the present invention to provide a door-to-door network that provides information on all doors, and to provide door to personal computer (PC) communication where service people collect information from all doors at a site by wirelessly connecting to one of the doors.

According to the present invention, a wireless radio transmission network comprises: one or more high-speed doors; one or more stationary radio transceivers, each of the one or more stationary radio transceivers having a unique identifier; and one or more mobile radio transceivers, each of the one or more mobile radio transceivers having a unique identifier; wherein when a mobile transceiver approaches within a predetermined distance of a stationary transceiver and when the unique identifier of the stationary transceiver verifies that the unique identifier of the mobile transceiver is an acceptable identifier, a high-speed door is triggered to open.

According to the present invention there is provided a wireless radio transmission network wherein the one or more stationary radio transceivers are mounted on or adjacent to the one or more high-speed doors, wherein the one or more mobile radio transceivers are wireless, battery-operated hand-held units and are mounted on one or more vehicles, wherein the wireless radio transmission network further comprises a concentrator for collecting status information on the one or more high-speed doors, wherein a service representative wirelessly connects to the display unit to collect the status information on the one or more high-speed doors or connects to one of the one or more high-speed doors to collect the status information on the one or more high-speed doors; and wherein one of the one or more high-speed doors wirelessly transfers its status information to another door of the one or more high-speed doors.

According to the present invention there is provided a wireless radio transmission network wherein the display unit is located within a close proximity of the one or more high-speed doors or at a remote location from the one or more high-speed doors, wherein the one or more mobile radio transceivers and the one or more stationary radio transceivers include light emitting diodes (LEDs) to indicate operation activity to a user, wherein the unique identifiers of the one or more stationary and mobile radio transceivers are radio frequency (RF) identifiers or infrared (IR) identifiers, wherein the unique identifiers of the one or more stationary and mobile radio transceivers are located on or in their respective transceivers, wherein the network operates in a plurality of bands, wherein the plurality of bands are six, one band for common short open/close communication, one band used as a backup, and the other four bands reserved for special usage, such as communication with a service representative and wherein the one or more mobile radio transceivers each adjust their signal sensitivity level in order to minimize interference effects.

The various features of novelty, which characterize the invention, are pointed out in particularity in the claims annexed to and forming a part of this disclosure. For a better understanding of the invention, its operating advantages and specific objects attained by its uses, reference is made to the accompanying descriptive matter in which preferred embodiments of the invention are illustrated.

### BRIEF DESCRIPTION OF THE DRAWINGS

Thus by the present invention, its objects and advantages will be realized, the description of which should be taken in conjunction with the drawing wherein:

FIG. 1 is a diagram of a radio transmission network where stationary transceivers are mounted on a plurality of doors;

FIG. 2 is a diagram of a radio transmission network where stationary transceivers are mounted next to a plurality of doors;

FIG. 3 is a system that describes the radio frequency identification (RFID) operation between a mobile transceiver and a stationary transceiver;

### DETAILED DESCRIPTION OF THE INVENTION

The present invention is directed to novel methods of radio transmission for door applications by utilizing transceivers instead of transmitter/receiver configurations.

Transceivers

A transmitter is a device that converts electrical signals for transmission to a distant point. A receiver is a device whose purpose is to capture transmitted signal energy (from the transmitter) and convert that energy for useful functions. Typically, a conventional transmitter repeats a message a number of times and always with full power. The transmitter repeats a message several times until the transmitter receives an acknowledgement from the intended receiver that the message was received successfully.

In contrast to the transmitter/receiver configuration, a transceiver is a combination of a transmitter/receiver in a single package. In other words, a transceiver is a device that combines both functions of the transmitter and receiver, thereby providing both output and input interfaces. A transceiver is extensively used in two-way radio communications at all frequencies. Moreover, a transceiver has power and cost advantages over traditional transmitters because a transceiver does not repeat messages a number of times at full power.

The term transceiver applies to wireless communication devices such as hand-held two-way radios and mobile two-way radios. In a radio transceiver, the receiver is silenced while transmitting. An electronic switch allows the transmitter and receiver to be connected to the same antenna, and prevents the transmitter output from damaging the receiver. This mode is called the half-duplex mode.

On the other hand, the transceivers of the present invention operate in the full-duplex mode. The full-duplex mode transceivers are designed to allow reception of signals during transmission periods and require the transmitter and the receiver to operate on different frequency bands so that the transmitted signal does not interfere with reception. This full-duplex transceiver configuration is described below according to the two embodiments of the present invention.

### First Embodiment

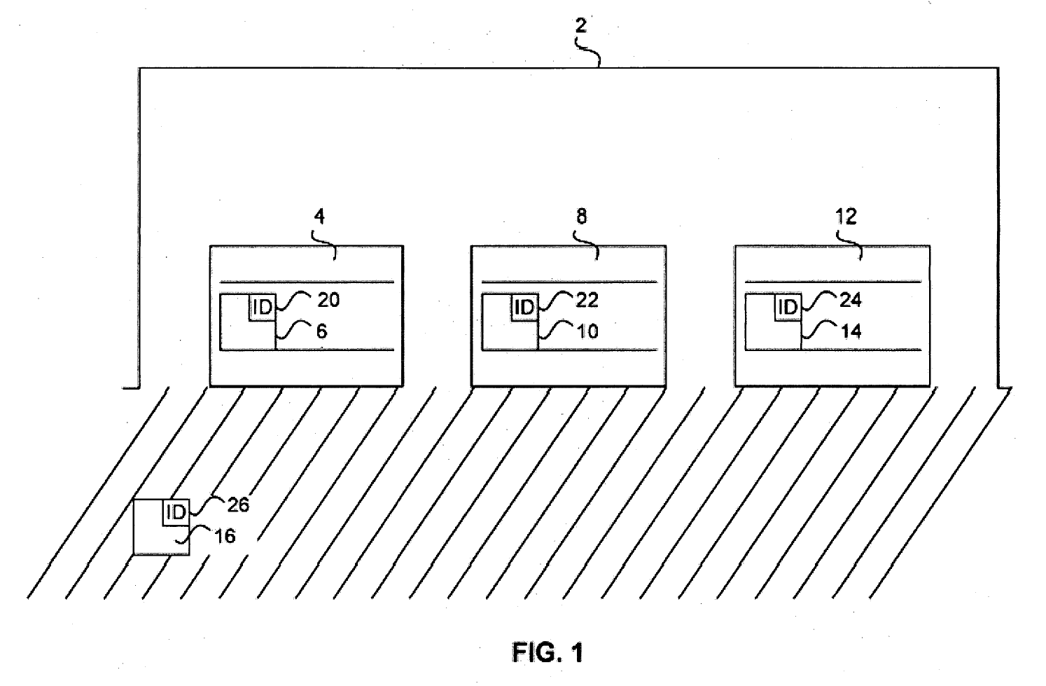

A first embodiment of the radio transmission network according to the present invention is described with reference to FIG. 1. FIG. 1 illustrates a system or radio transmission network where stationary transceivers are mounted on a plurality of respective doors.

In this example, as shown in FIG. 1, a building 2 comprises three doors 4, 8, 12. Stationary transceivers 6, 10, 14 are mounted on each of the three doors 4, 8, 12, respectively. Each of the stationary transceivers 6, 10, 14 incorporates identifiers 20, 22, 24, respectively. When a mobile transmitter 16 approaches the vicinity of door 4, door 4 opens automatically.

More specifically, a worker using a forklift (not shown) carries a hand-held mobile transceiver 16 or the mobile transceiver 16 is mounted on the forklift itself. Once the forklift carrying the mobile transceiver 16 is located at a predetermined distance away from the door 4, the mobile transceiver 16 triggers the stationary transceiver 6 located on the door 4. Once the stationary transceiver 6 receives a trigger signal, the door 4 automatically opens at a rapid speed in order to allow the worker on the forklift to enter through the door 4. The triggering is activated once the identifier 20 of the stationary transceiver 6 verifies that the identifier 26 of the mobile transceiver 16 is permitted to open door 4. This system allows individuals that constantly move through different doors in different buildings of the same facility to move products quickly and efficiently.

The predetermined distance between the stationary transceiver and the mobile transceiver is a value that can be set by the manufacturer at the request of the customer. However, the predetermined distance can also be a value that is set by the customer upon delivery. The predetermined distance can further be changed to desired values at any time either directly by the customer or remotely by the manufacturer.

Moreover, the system illustrated in FIG. 1 is a local area network (LAN), and more specifically a wireless LAN. A wireless LAN is one in which a mobile user connects to a LAN through a wireless (radio) connection. A standard, IEEE 802.11, specifies the technologies for wireless LANs.

In addition, the wireless LAN of FIG. 1 incorporates various wireless configurations. For example, the term “wireless” can be divided into the following wireless configurations: (i) fixed wireless, which is the operation of wireless devices or systems in homes and offices, and in particular, equipment connected to the Internet via modems, (ii) mobile wireless, which is the use of wireless devices or systems aboard motorized, moving vehicles, (iii) portable wireless, which is the operation of autonomous, battery-powered wireless devices or systems outside the office, home, or vehicle, such as handheld cell phones, and (iv) IR wireless, which is the use of devices that convey data via IR (infrared) radiation; examples include limited-range communications and control systems.

### Second Embodiment

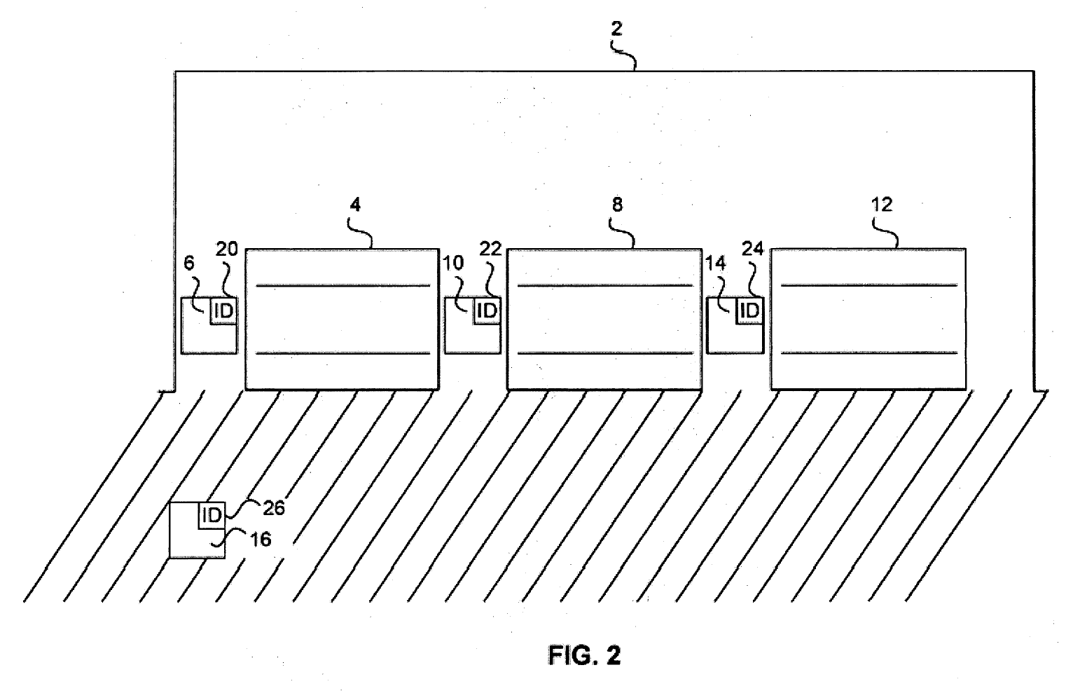

A second embodiment of the radio transmission network according to the present invention is described with reference to FIG. 2. FIG. 2 illustrates a system or radio transmission network where the stationary transceivers are mounted next to the plurality of doors.

The reference numerals of FIG. 2 denote the same elements as in FIG. 1. The difference between FIGS. 1 and 2 is that the stationary transceivers 6, 10, 14 are located next to the doors 4, 8, 12, respectively (as in FIG. 2), for example, on a wall, instead of being mounted directly on the doors 4, 8, 12 (as in FIG. 1).

Again, for instance, if a forklift carrying the mobile transceiver 16 is located at a predetermined distance away from the door 4, the mobile transceiver 16 triggers the stationary transceiver 6 located next to the door 4. Once the stationary transceiver 6 receives a trigger signal, the door 4 automatically opens at a rapid speed in order to allow a worker on the forklift to enter through the door 4. The triggering is activated once the identifier 20 of the stationary transceiver 6 verifies that the identifier 26 of the mobile transceiver 16 is permitted to open door 4. This system allows a worker to continue doing his or her job without having to continuously stop the operation of the forklift in order to open and close doors.

Also, as in the first embodiment, the predetermined distance between the stationary transceiver and the mobile transceiver is a value that can be set by the manufacturer at the request of the customer. However, the predetermined distance can also be a value that is set by the customer upon delivery. The predetermined distance can further be changed to desired values at any time either directly by the customer or remotely by the manufacturer. Moreover, the second embodiment is also considered a local area network (LAN), and more specifically a wireless LAN.

Furthermore, in both the first and second embodiments of the present invention, the mobile radio transceiver 16 and the stationary radio transceivers 6, 10, 14 may include light emitting diode (LED) lights in order to indicate operation activity to a user. This enables the user of the mobile or stationary radio transceiver to be aware if the transceiver is ON, is OFF or if the battery power indicator is low and needs to be replaced.

Local Area Networks (LANs)

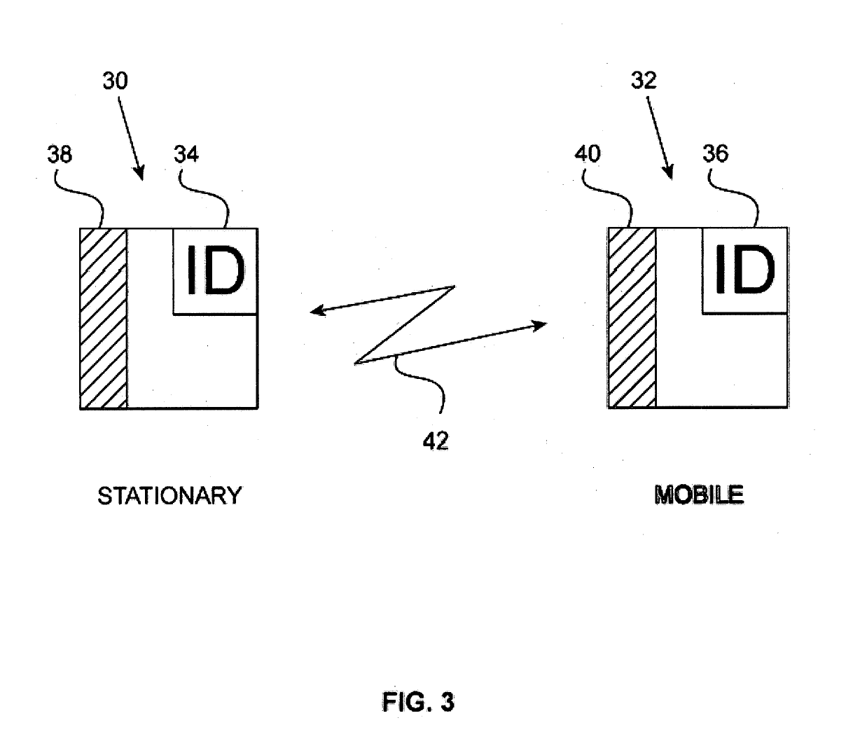

In order to montior the plurality of doors 4, 8, 12 in a wireless LAN network as shown in FIGS. 1 and 2, each of the plurality of doors 4, 8, 12 has an RF identifier 20, 22, 24, respectively. Also the mobile transceiver 16 has an RF identifier 26. The communication between a stationary transceiver 30 and a mobile tranceiver 32 is described with reference to FIG. 3. Specifically, FIG. 3 is a system that describes the radio frequency identification (RFID) operation between a mobile transceiver 32 and a stationary transceiver 30.

In this example, the mobile transceiver 32 includes an identifier 36 and an antenna 40. The stationary transceiver 30 includes an identifier 34 and an antenna 38. When the mobile transceiver 32 is located at a predetermined distance away from the stationary transceiver 30, a signal 42 is transmitted from the mobile transceiver 32 to the stationary transceiver 30. The signal 42 is verified by the stationary transceiver 30 in order to determine whether or not the user of the mobile transceiver 32 is permitted to access the door linked to the stationary transceiver 30.

If it is determined that the user of the mobile transceiver 32 is permitted to access the door linked to the stationary transceiver 30, then the door rapidly opens and the user of the mobile transceiver 32 is allowed to go through such door.

If it is determined that the user of the mobile transceiver 32 is not permitted to access the door linked to the stationary transceiver 30, then the door does not open and the user of the mobile transceiver 32 is not allowed to go through such door.

The activity of the user (entering doors) is constantly recorded and transmitted to a host computer or concentrator, descibed in detail later.

The wireless LAN of the present invention is a network designed to carry data from one computer to another (or from one door to the other) in a localized area, for example, within one or more buildings. The wireless LAN system is different than a Wide Area Network (WAN) system, which is designed to carry data from one computer to another over a great distance, for example, from one country to another.

Conventional LAN system hardware utilizes some form of wiring to carry the signal from one location to another location (or from one door to another door). Coaxial, twisted pair or fiber optic cable is most commonly used as the form of connection. The data to be carried over the LAN is broken up into small pieces or chunks, called packets, which are sent over the wires and combined back into the original file (or data) at the far end of the system. Various methods are used to manage who gets to use the wires at any given time. Nevertheless, in the present invention, a wireless LAN system is preferred. In a wireless LAN system, the same functions occur as in a conventional wired LAN system. The main difference is that the wires are replaced by a radio link.

However, a wireless LAN system has both advantages and disadvantages. One disadvantage or common problem with wireless LAN networks is interference. In wired LANs, the only machines or equipment that are heard are the ones connected to the network. In a wireless LAN you may hear other, nearby networks, as well as cordless phones, personal digital assistants (PDAs), portable personal computers (PCs), other transmitters and transmissions from other licensed services. Any of these devices may interfere with the transmission of data or the transmission of a signal.

The solution to the interference problem is solved with a technique known as spread spectrum communications. Spread spectrum uses methods that spread the signal out over a larger bandwidth than normal to obtain resistance to interference.

There are two main methods of spread spectrum. These methods are (i) frequency hopping and (ii) direct sequence. In frequency hopping systems, the transmitter and receiver constantly change channels, ensuring that any interference received lasts only for a short duration (while the units are tuned to the frequency where the interference is detected). Data lost during those short periods is easily re-transmitted so that no information or data is lost. In direct sequence systems, the data is combined with a high-speed digital code, which spreads the transmitted energy over a wide range. A copy of the code is used at the far end to “de-spread” or recover the original signal, while rejecting the interfering signals.

In the two embodiments of the present invention, the mobile and stationary transceivers utilize one of the two above-mentioned mechanisms that minimize interference to very low levels. The objective is not to eliminate all interferences at a 100% level, but to minimize such interferences to such levels that do not hinder the communication between the mobile and stationary transceivers.

Moreover, the radio transmission network that comprises one or more mobile and stationary transceivers preferably operates in a plurality of bands. An example is described below with a radio transmission network that includes 6 bands. Of course, any number of bands may be used to receive and transmit signals or data.

Each of the 6 bands has a different frequency operation and is used for different purposes. One band is used for a common short open/close message communication. Another band is used as a backup if disturbances arise on the normal band. The other four bands are reserved for special usage, such as wireless communication or communication with a service representative. Every change of band is ordered through the main band or the backup band. At short ranges the maximum bandrate is 115 kbits/s.

Radio Frequency Identifier or Identification (RFID)

The mobile and stationary transceivers of the present invention may use Radio frequency (RF) technology or Infrared (IR) technology to communicate with each other.

Radio frequency (RF) technology is used in many different applications, such as television, radio, cellular phones, radar, and automatic identification systems. RF technology is also used to trigger or activate the mobile and stationary transceivers of the present invention.

RF refers to electromagnetic waves that have a wavelength suited for use in radio communication. Radio waves are classified by their frequencies, which are expressed in kilohertz (kHz), megahertz (MHz), or gigahertz (GHz). Radio frequencies range from very low frequency (VLF), which has a range of 10 to 30 kHz, to extremely high frequency (EHF), which has a range of 30 to 300 GHz.

On the other hand, infrared (IR) technology is used in many different applications, such as scanning bar codes. Infrared remote controls work in much the same way as radio remotes, except that instead of transmitting the signal over radio waves, the signal is transmitted using pulses of infrared light. Infrared light is just below the red portion of the visible spectrum, and so is invisible to the human eye. Infrared remote-control devices have one major difference from radio frequency devices. IR devices use light to transmit data, and therefore are not able to penetrate walls and work around corners very well.

Both Radio frequency (RF) technology and Infrared (IR) technology may be used to allow the mobile and stationary transceivers to communicate with each other in the present invention. Nevertheless, both technologies require the incorporation of identification technologies in order to be effective. An RF identification technology is described below, since RF communication is preferred to IR communication in the present invention.

The term RFID (radio frequency identification) describes the use of radio frequency signals that provide automatic identification of items. RFID is used in identification, tracking, and access control of the mobile and stationary transceivers of the present system.

RFID is a flexible technology that is convenient, easy to use, and well suited for automatic operation. It combines advantages not available with other identification technologies (e.g. IR technology). RFID may be supplied as read-only or read/write, does not require contact or line-of-sight to operate, may function under a variety of environmental conditions, and provides a high level of data integrity. In addition, because RF technology is difficult to counterfeit, RFID provides a high level of security.

RFID is similar in concept to bar coding. Bar code systems use a reader and coded labels that are attached to an item, whereas RFID uses a reader and special RFID devices that are attached to or incorporated within an item. Bar code uses optical signals to transfer information from the label to the reader. RFID uses RF signals to transfer information from the RFID device to the reader.

Radio waves transfer data between an item to which an RFID device is attached and an RFID reader. The RFID device contains data about the item (i.e., the mobile radio transceiver), such as what the item is, what time the device traveled through a certain zone, when was the last time the item traveled through a certain zone, how many zones the item traveled through, etc. RFID devices, such as a tag or label, may be attached to virtually anything, e.g. directly on industrial doors or on a wall next to an industrial door.

RFID technology uses frequencies within the range of 50 kHz to 2.5 GHz. An RFID system typically includes the following components: (i) an RFID device (mobile or stationary transceiver) that contains data about an item, (ii) an antenna used to transmit the RF signals between the reader and the RFID device, (iii) another RF transceiver that generates the RF signals, and (iv) a reader that receives RF transmissions from an RFID device and passes the data to a host computer or concentrator for processing.

An RFID device that actively transmits to a reader is referred to as an “active” tag. An RFID device that only reflects or scatters back transmission from a reader is referred to a “passive” tag.

The tags are programmed with data that identifies the item to which the tag is attached. Tags are either read-only, volatile read/write, or write one/read many and may be either active or passive. In general, active tags use batteries to power the mobile and stationary transceivers. These tags usually contain a greater number of components than do passive tags. Therefore, active tags are usually larger in size and are more expensive than passive tags. In addition, the life of an active tag is directly related to battery life.

Passive tags are either battery or non-battery operated, as determined by the intended applications. Passive tags reflect the RF signal transmitted to them from a reader or transceiver and add information by modulating the reflected signal. A passive tag does not use a battery to boost the energy of the reflected signal. A passive tag may use a battery to maintain memory in the tag or power the electronics that enable the tag to modulate the reflected signal.

Furthermore, each RFID system includes at least one antenna to transmit and receive RF signals. In the systems of the present invention, a single antenna transmits and receives the signals. The quantity, quality and type of antenna used depends on the application.

The RF transceiver is the source of the RF energy used to activate and power the passive RFID tags. The RF transceiver may be enclosed in the same encasing as the reader or it may be a separate piece of equipment. When provided as a separate piece of equipment, the transceiver is commonly referred to as an RF module. The RF transceiver controls and modulates the radio frequencies that the antenna transmits and receives. The transceiver filters and amplifies the backscatter signal from a passive RFID tag.

The RFID reader directs the RF transceiver to transmit RF signals, receives the encoded signal from the tag through the RF transceiver, decodes the tag's identification, and transmits the identification with any other data from the tag to a host computer or concentrator. The user may change or customize the reader's operations to suit a specific requirement by issuing commands through the host computer or the concentrator.

Concentrator and Communication Status

A concentrator is a device that reports the status of the plurality of doors to a user. The status information of the plurality of doors is displayed on a display unit. The display unit may be located within the local radio transmission network or can be located at a remote location. The remote location may be, for instance, the ability to monitor all the doors from a central location.

Concerning the various functions of the display unit, a signal input level received by the mobile transceiver is measured, stored, and then displayed on the display unit of the radio transmission network.

The constant monitoring of the signal input levels makes it possible for the mobile transceivers to adjust their signal sensitivity levels. Therefore, the disturbance (or interference) of other radio traffic in the proximity of the mobile radio transceiver is minimized and the mobile transceiver adjusts itself to automatically operate at less than full transmit power. On the other hand, if no response is detected by the mobile radio transceiver, then the mobile radio transceiver changes to full transmit power.

In addition, if no response is detected by the mobile radio transceiver, then the mobile radio transceiver assumes that there is something wrong with a door, for example door 4 (as shown in FIG. 1), and alarm the other doors, for example doors 8, 12 located in the vicinity of door 4. Therefore, if a worker passes by door 12, the stationary transceiver indicates (e.g., with a flashing LED) that door 4 has a problem. The worker may thus be informed of problems related to any door within a building or a facility that includes a plurality of building by only checking one door within the facility.

To summarize, one of the one or more high-speed doors is able to wirelessly transfer its status to another door within the radio transmission network. Therefore, a faulty door is capable of transmitting its status through the wireless transmission network and have its status displayed on a display unit. The display unit may be located at a remote location or may be located within the local facility. For example, the display unit may be located at a central office within a building or may be located on or next to another door. Also, a specific door (e.g. door 4) can have a display unit that displays the status of all the other doors and report such status to a user passing by door 4.

Moreover, a direct connection to a service representatives or organization that provides service or maintenance operations is also possible. Thus, a faulty door is capable of transmitting its status through the wireless transmission network to a display unit in a remote location that is monitored by service representatives or maintenance personnel.

In addition to establishing a direct connection to a service representatives or organization that provides service or maintenance operations, an off-site service representative or maintenance worker is capable of going to a facility that has a plurality of high-speed doors, each of which has a transceiver, and log onto a stand-alone PC unit and collect information regarding the status of all the doors of the facility. The maintenance worker may have a hand-held wireless unit that connects to the stand-alone PC and extracts useful information regarding the status of all the doors of the facility, without having to personally check each and every door of the facility.

Consequently, in both the first and second embodiments of the present invention, since the transceiver is a standard or common transceiver, the logistics of the system or wireless transmission network are minimized. Moreover, a transceiver is presented that receives acknowledgment of receipt of a command from a door unit, thus reducing prior art transmitter repetitions and thus saving battery power.

Furthermore, a system and method for utilizing a transceiver configuration in a local area network (LAN) environment in order to rapidly and efficiently open and close doors is presented, wherein the system reduces the cost of present remote control systems by reducing the hardware associated with such remote control systems.

Although preferred embodiments of the present invention and modifications thereof have been disclosed and described in detail herein, it is to be understood that this invention is not limited to those precise embodiments and modifications, and that other modifications and variations may be effected by one skilled in the art without departing from the spirit and scope of the invention as defined by the appended claims.

1. A wireless radio transmission network comprising:
one or more high-speed doors;
one or more stationary radio transceivers, each of said one or more stationary radio transceivers having a unique identifier; and
one or more mobile radio transceivers, each of said one or more mobile radio transceivers having a unique identifier;
wherein when a mobile transceiver approaches within a predetermined distance of a stationary transceiver and when the unique identifier of the stationary transceiver verifies that the unique identifier of the mobile transceiver is an acceptable identifier, a high-speed door is triggered to open.

2. The wireless radio transmission network according to claim 1, wherein said one or more stationary radio transceivers are mounted on or adjacent to said one or more high-speed doors.

3. The wireless radio transmission network according to claim 1, wherein said one or more mobile radio transceivers are wireless, battery-operated hand-held units and are mounted on one or more vehicles.

4. The wireless radio transmission network according to claim 1, wherein said wireless radio transmission network further comprises a concentrator for collecting status information on said one or more high-speed doors.

5. The wireless radio transmission network according to claim 4, wherein said wireless radio transmission network further comprises a display unit for displaying status information on said one or more high-speed doors, said status information received from said concentrator.

6. The wireless radio transmission network according to claim 5, wherein a service representative wirelessly connects to said display unit to collect said status information on said one or more high-speed doors or connects to one of said one or more high-speed doors to collect said status information on said one or more high-speed doors; and
wherein one of said one or more high-speed doors wirelessly transfers its status information to another door of said one or more high-speed doors.

7. The wireless radio transmission network according to claim 5, wherein said display unit is located within a close proximity of said one or more high-speed doors or at a remote location from said one or more high-speed doors.

8. The wireless radio transmission network according to claim 1, wherein said one or more mobile radio transceivers and said one or more stationary radio transceivers include light emitting diodes (LEDs) to indicate operation activity to a user.

9. The wireless radio transmission network according to claim 1, wherein the unique identifiers of the one or more stationary and mobile radio transceivers are radio frequency (RF) identifiers or infrared (IR) identifiers.

10. The wireless radio transmission network according to claim 1, wherein the unique identifiers of the one or more stationary and mobile radio transceivers are located on or in their respective transceivers.

11. The wireless radio transmission network according to claim 1, wherein the network operates in a plurality of bands, the plurality of bands being six bands, one band for common short open/close communication, one band used as a backup, and the other four bands reserved for special usage, such as communication with a service representative.

12. The wireless radio transmission network according to claim 1, wherein the one or more mobile radio transceivers each adjust their signal sensitivity level in order to minimize interference effects.

13. A method of opening and closing one or more high-speed doors in a wireless radio transmission network, said method comprising the steps of:
providing one or more stationary radio transceivers, each of said one or more stationary radio transceivers having a unique identifier; and
providing one or more mobile radio transceivers, each of said one or more mobile radio transceivers having a unique identifier;
wherein when a mobile transceiver approaches within a predetermined distance of a stationary transceiver and when the unique identifier of the stationary transceiver verifies that the unique identifier of the mobile transceiver is an acceptable identifier, a high-speed door is triggered to open.

14. The method according to claim 13, wherein said one or more stationary radio transceivers are mounted on or adjacent to said one or more high-speed doors.

15. The method according to claim 13, wherein said one or more mobile radio transceivers are wireless, battery-operated hand-held units and are mounted on one or more vehicles.

16. The method according to claim 13, wherein said radio transmission network further comprises a concentrator for collecting status information on said one or more high-speed doors.

17. The method according to claim 16, wherein said radio transmission network further comprises a display unit for displaying status information on said one or more high-speed doors, said status information received from said concentrator.

18. The method according to claim 17, wherein a service representative wirelessly connects to said display unit to collect said status information on said one or more high-speed doors or connects to one of said one or more high-speed doors to collect said status information on said one or more high-speed doors; and
wherein one of said one or more high-speed doors wirelessly transfers its status information to another door of said one or more high-speed doors.

19. The method according to claim 17, wherein said display unit is located within a close proximity of said one or more high-speed doors or at a remote location from said one or more high-speed doors.

20. The method according to claim 13, wherein said one or more mobile radio transceivers and said one or more stationary radio transceivers include light emitting diodes (LEDs) to indicate operation activity to a user.

21. The method according to claim 13, wherein the unique identifiers of the one or more stationary and mobile radio transceivers are radio frequency (RF) identifiers or infrared (IR) identifiers.

22. The method according to claim 13, wherein the unique identifiers of the one or more stationary and mobile radio transceivers are located on or in their respective transceivers.

23. The method according to claim 13, wherein the network operates in a plurality of bands, the plurality of bands being six bands, one band for common short open/close communication, one band used as a backup, and the other four bands reserved for special usage, such as communication with a service representative.

24. The method according to claim 13, wherein the one or more mobile radio transceivers each adjust their signal sensitivity level in order to minimize interference effects.
